(19) United States
(12) Patent Application Publication
(10) Pub. No.: US 2012/0081563 A1
(43) Pub. Date: Apr. 5, 2012

(54) POSITION-DEPENDENT CAMERA SWITCHING SYSTEM

(75) Inventor: Ralf HINKEL, Hoeringen (DE)

(73) Assignee: MOBOTIX AG, Winnweiler (DE)

(21) Appl. No.: 13/084,875

(22) Filed: Apr. 12, 2011

(30) Foreign Application Priority Data
Oct. 4, 2010 (DE) 10 2010 047 656.0
Dec. 1, 2010 (DE) 102010052880.3-31

(51) Int. Cl. H04N 5/232

(52) U.S. Cl. 348/211.99; 348/E05.042

(57) ABSTRACT

The invention relates to a method for displaying camera images on a remote, mobile viewing device, the viewing device having a screen with a different number of pixels in the longitudinal and transverse directions, a position sensor for determining an orientation of the viewing device and a request means for requesting camera image data from the camera arranged such that it is remote from the mobile viewing device. In this case, provision is made for the position sensor to first of all be used to determine whether the screen is oriented for displaying a portrait or landscape image, for an item of information based on the orientation detected using the position sensor to be transmitted from the mobile viewing device to the camera in order to request a camera image formatted in accordance with the portrait or landscape orientation from the remote camera via a bidirectional communication channel, and for the camera image to be received and displayed in the corresponding screen orientation.

The present invention relates to the subject matter claimed in the preamble and thus relates to the display of camera images on mobile viewing devices.

Cameras are increasingly being used to monitor critical locations and situations, images being transmitted from said cameras to remote viewing devices such as monitors and the like. It is already known practice to use mobile viewing devices, for example mobile telephones with a sufficiently large display, to display a stream of camera images or individual camera images.

When transmitting camera images, it should be regularly borne in mind that high-resolution camera images in rapid succession require a wide transmission bandwidth, which results in high communication costs and, with an inadequate data transmission speed, in only inadequate image display.

Therefore, a multiplicity of measures have already been taken to improve the transmission of image data. For example, in the case of cameras which can provide high-resolution images (in particular landscape images), only those sections which are of particular interest to the viewer are transmitted.

In this case, it is already possible to respectively transmit images only in standard image formats, such as VGA resolution, SVGA resolution and the like, irrespective of a higher camera resolution.

Modern mobile telephones, for instance the “iPhone” from APPLE, now have sufficiently large image displays which allow a camera image or a section of a camera image to be displayed such that monitoring becomes possible via the display.

Moreover, it is known practice, in the case of mobile viewing devices such as mobile telephones, to provide a position sensor which, when recording images using the mobile telephone's own camera, can indicate whether an image has been recorded with a portrait or landscape orientation.

The practice of storing the camera orientation with images is also known from photography.

It is desirable to be able to display camera images from remote monitoring cameras on mobile viewing devices in an improved manner.

The solution to this problem is claimed in independent form. Preferred embodiments are found in the subclaims.

The invention thus first of all proposes a method for displaying camera images on a remote, mobile viewing device, the viewing device having a screen with a different number of pixels in the longitudinal and transverse directions, a position sensor for determining an orientation of the viewing device and a request means for requesting camera image data from the camera arranged such that it is remote from the mobile viewing device. In this case, provision is made for the position sensor to first of all be used to determine whether the screen is oriented for displaying a portrait or landscape image, for corresponding information to be transmitted to the camera, for a camera image formatted in accordance with the portrait or landscape orientation to be requested from the remote camera via a bidirectional communication channel, and for the camera image to then be displayed in the corresponding screen orientation.

It has thus been recognized that the position sensor present in mobile telephones and other mobile viewing devices can be used to reduce the incoming volume of data, while the image quality of camera images remains the same, if the remote camera is informed of the respective desired orientation; the remote counterpart station camera must then only be able to display image sections either in portrait format or in landscape format; this is readily possible in conventional cameras since they are equipped to transmit different output image formats, such as VGA, SVGA, 16:9, 16:10, 4:3 ratios, anyway. It is only necessary to configure the cameras in such a manner that, in addition to an image in the 16:9 format for instance, an image in the 9:16 format can also be provided, etc. The corresponding programming on the camera side is thus readily possible. It is also possible to provide appropriate different resolutions, for example in order to support different display resolutions in different mobile telephones or different generations of a mobile radio type. Transmitting the current orientation of the mobile viewing device results in only a small load on the data transmission channel despite optimum use of the number of pixels given in the respective longitudinal and transverse directions according to the orientation on the mobile viewing device, for example an iPhone, which improves the communication costs, the amount of communication energy required etc. with a viewing result which is nevertheless optimum.

It is preferred if communication is carried out using a web interface, for example when Internet cameras (webcams and the like) are addressed.

During communication, general contact between the mobile telephone and the camera can thus first of all be established, which may involve transmitting authorization data (passwords etc.) and transmitting data which are specific to the viewing device, such as image resolution in the longitudinal and transverse directions, the frame rate which can be displayed or the desired frame rate etc. This may also be carried out while assessing the data transmission quality. An item of information relating to the current orientation is then recorded by the position sensor on the mobile viewing device, that is to say it is determined whether a user is holding the mobile viewing device in such a manner that the longer side of the screen is horizontal (landscape display) or upright (portrait format). This information is then transmitted to the camera, typically in coded form. This may be carried out either by specifying an exact resolution ratio, for example by transmitting a browser applet command “640×480” or “480×640”, or else by appropriately transmitting flags such as “upright=false”.

The camera will then provide an image stream in a manner known per se, which image stream corresponds exactly to this request. It is pointed out that the method can additionally provide for swivel or tilt control, which can be effected, in particular in the case of hemispherical cameras, by specifying a desired image center point or the position of a particular image corner in a larger image field. Zoom parameters may likewise be specified. Depending on the computation power and desired use, wide-angle images can incidentally be rectified on the camera side or viewing device side. For the rest, reference is made to the different applications by the applicant relating to the transmission of sections, camera control commands etc. by browser applet or in another manner. These are comprehensively incorporated for the purposes of disclosure.

It is possible and preferred for the positional orientation to be repeatedly checked in the mobile viewing device. A corresponding item of information relating to the current position can then be transmitted to the camera either cyclically or repeatedly in another manner. In particular, it is possible and preferred for an item of information relating to a change in position to be sent to the camera whenever the orientation, as detected using the position sensor in the viewing device, has actually changed. A particular advantage also results from the fact that the transmitted images no longer have to be adapted in a complicated manner in the mobile viewing device. This reduces the computation load on the mobile viewing device.

It is also disclosed as inventive per se, or preferably in combination with the determination of the positional orientation, that suitable sensors on the mobile viewing device, in particular accelerometers, can be used to detect a movement of the viewing device and swivel movements of the device can be determined therefrom. These determined swivel movements can then be used to derive a swivel parameter for the camera image or the image section which is intended to be transmitted from the camera to the mobile viewing device, and a corresponding image section or a corresponding image can be requested. The movements detected using the acceleration sensors and the like on the mobile viewing device are first of all preferably evaluated in such a manner that shaking or the like does not result in a corresponding request for a shaking camera image, but rather only uniform larger movements are used to swivel in the camera image, for example. The request for a camera image to be transmitted can then either be made, in particular in the case of hemispherical or very wide-angle camera images recorded with a high resolution, in such a manner that only a section corresponding to the respective swivel movement is transmitted, or the camera can actually also be physically swiveled, if necessary. This results in particularly intuitive operation.

It is also pointed out that a movement of the mobile viewing device away from the viewer or toward the viewer may possibly be interpreted as a zoom movement. Intuitive zoom control can also be provided in this manner if a corresponding zoom section is intended to be requested. In this case, a jerky movement of the mobile viewing device toward the viewer or away from the viewer can be used, for example, to trigger an image section which is changed by changing a zoom factor.

It is mentioned that the method of the invention can be used with conventional compression methods such as MxPEG coding. In the case of particular compression systems in which a reference frame is used, a new reference frame is preferably respectively requested in the event of a format change caused by a change in position, or the process waits for a format change, in the case of a sufficiently fast reference frame sequence, until the next reference frame.

1. A method for displaying camera images on a remote, mobile viewing device, the viewing device having a screen with a different number of pixels in the longitudinal and transverse directions, a position sensor for determining an orientation of the viewing device and a request means for requesting camera image data from the camera arranged such that it is remote from the mobile viewing device, wherein the position sensor is first of all used to determine whether the screen is oriented for displaying a portrait or landscape image, an item of information based on the orientation detected using the position sensor is transmitted from the mobile viewing device to the camera in order to request a camera image formatted in accordance with the portrait or landscape orientation from the remote camera via a bidirectional communication channel, and the camera image is received and displayed in the corresponding screen orientation.

2. The method as claimed in the preceding claim, wherein the request is transmitted to the camera via a web interface.

3. The method as claimed in one of the preceding claims, wherein the screen orientation is repeatedly checked and camera images formatted in a different manner are requested when the screen orientation changes.

4. The method as claimed in one of the preceding claims, wherein images corresponding to the number of pixels given in the longitudinal and transverse directions and corresponding to the image orientation are requested from the camera and these are accordingly transmitted to the camera, in particular by selecting a section from a larger camera image (zoom) and/or by compressing given higher-resolution raw image data.

5. The method as claimed in one of the preceding claims, wherein a movement is detected on the mobile viewing device, in particular using acceleration sensors in the x and y directions of the screen, and a section of a larger camera image, determined by swiveling, is requested according to a detected swivel movement of the viewing device.
